(19) United States
(12) Patent Application Publication
(10) Pub. No.: US 2025/0271574 A1
(43) Pub. Date: Aug. 28, 2025

(54) DEPTH SENSING DEVICE AND DEPTH SENSING METHOD

(71) Applicant: HIMAX TECHNOLOGIES LIMITED, Tainan City (TW)

(72) Inventors: Wu-Feng Chen, Tainan City (TW); Hsueh-Tsung Lu, Tainan City (TW)

(73) Assignee: HIMAX TECHNOLOGIES LIMITED, Tainan City (TW)

(21) Appl. No.: 18/586,576

(22) Filed: Feb. 26, 2024

(51) Int. Cl. G01S 17/46; G01S 17/894

(52) U.S. Cl. CPC G01S 17/46; G01S 17/894

(57) ABSTRACT

A depth sensing device and a depth sensing method are provided. The depth sensing device includes a processor, a dot projector, and a camera. The dot projector is coupled to the processor. The dot projector projects a plurality of amplitude modulated optical signals to a sensing target. The camera is coupled to the processor. The camera photographs a plurality of reflected light signals from the sensing target to obtain a plurality of dot images. The processor generates a first reference depth map of indirect time-of-flight ranging and a second reference depth map of structured light ranging according to the plurality of dot images. The processor generates a depth map corresponding to the sensing target according to the first reference depth map and the second reference depth map.

### BACKGROUND

### Technical Field

The disclosure relates a sensing technology, particularly, the disclosure relates to a depth sensing device and a depth sensing method.

### Description of Related Art

With the rise of computer vision applications in various industries, various three-dimensional (3D) depth sensor technologies are booming. In particular, indirect time-of-flight (iToF) 3D sensing technology has the advantages of high detection rate, small module size, low cost and depth spatial resolution performance, so it is widely used in fields such as vision and autonomous driving. In this regard, since the iToF module uses amplitude modulation as the basis for calculation, the application distance of the module will be limited by the amplitude modulation signal period, so the calculated phase delay is only be limited to 0˜2π.

The traditional way to increase the distance of iToF applications is to use two or more sets of modulation period signals, project and output them sequentially, and sample them, receive the results with multiple sets of frequencies, calculate the distance results respectively, and then use the difference between the multiple sets of distances. The object distance corresponds to the periodic analysis of two sets of frequencies. However, when multiple sets of modulation frequencies are used to shoot in sequence, due to different optical and electrical driving characteristics of different modulation frequencies, or different shooting settings, the result may be a difference in brightness between images, as well as depth decoding settings. The adjustment is difficult, which may cause flickering problems in applications. In dynamic use, the corresponding depth may be incorrect due to the movement of objects captured in the two frequencies.

### SUMMARY

The depth sensing device of the disclosure includes a processor, a dot projector, and a camera. The dot projector is coupled to the processor. The dot projector projects a plurality of amplitude modulated optical signals to a sensing target. The camera is coupled to the processor. The camera photographs a plurality of reflected light signals from the sensing target to obtain a plurality of dot images. The processor generates a first reference depth map of indirect time-of-flight ranging and a second reference depth map of structured light ranging according to the plurality of dot images. The processor generates a depth map corresponding to the sensing target according to the first reference depth map and the second reference depth map.

The depth sensing method of the disclosure includes the following steps: projecting a plurality of amplitude modulated optical signals to a sensing target by a dot projector; and photographing a plurality of reflected light signals from the sensing target to obtain a plurality of dot images by a camera; generating a first reference depth map of indirect time-of-flight ranging and a second reference depth map of structured light ranging according to the plurality of dot images; and generating a depth map corresponding to the sensing target according to the first reference depth map and the second reference depth map.

Based on the above, according to the depth sensing device and the depth sensing method of the disclosure, the depth sensing device can effectively obtain a depth information of a sensing target.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram of a depth sensing device according to an embodiment of the disclosure.

FIG. 2 is a flow chart of a depth sensing method according to an embodiment of the disclosure.

FIG. 3 is a schematic diagram of data processing according to an embodiment of the disclosure.

FIG. 4 is a schematic diagram of multiple first reference depths and multiple second reference depths according to an embodiment of the disclosure.

FIG. 5 is a schematic diagram of a depth difference data according to an embodiment of the disclosure.

### DESCRIPTION OF THE EMBODIMENTS

Reference will now be made in detail to the exemplary embodiments of the disclosure, examples of which are illustrated in the accompanying drawings. Whenever possible, the same reference numbers are used in the drawings and the description to refer to the same or like components.

Certain terms are used throughout the specification and appended claims of the disclosure to refer to specific components. Those skilled in the art should understand that electronic device manufacturers may refer to the same components by different names. This article does not intend to distinguish those components with the same function but different names. In the following description and rights request, the words such as “comprise” and “include” are open-ended terms, and should be explained as “including but not limited to . . . ”

The term “coupling (or electrically connection)” used throughout the whole specification of the present application (including the appended claims) may refer to any direct or indirect connection means. For example, if the text describes that a first device is coupled (or connected) to a second device, it should be interpreted that the first device may be directly connected to the second device, or the first device may be indirectly connected through other devices or certain connection means to be connected to the second device.

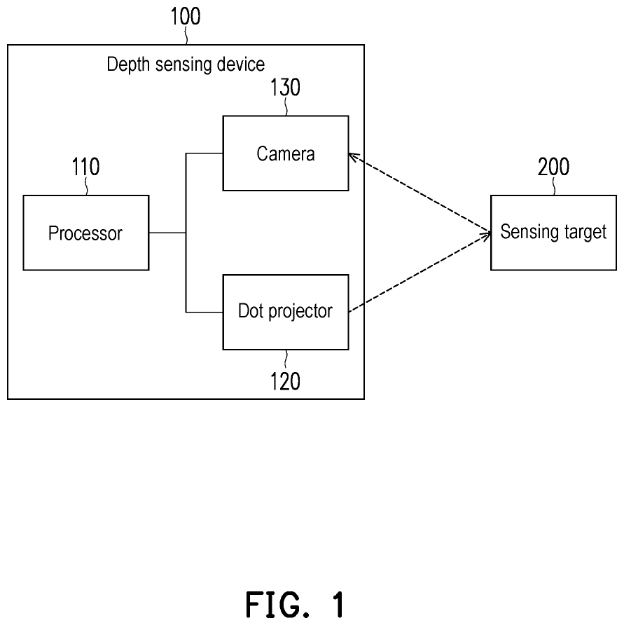

FIG. 1 is a schematic diagram of a depth sensing device according to an embodiment of the disclosure. Referring to FIG. 1, the depth sensing device 100 includes a processor 110, a dot projector 120, and a camera 130. The processor 110 is coupled to the dot projector 120 and the camera 130. In the embodiment of the disclosure, the depth sensing device 100 is configured to sense a depth information of a sensing target 200. The depth sensing device 100 projects a plurality of sensing optical signals (i.e. a plurality of light pulses) to the sensing target 200 through the dot projector 120, and receives a plurality of reflect optical signals (i.e. a plurality of reflect light pulses) from the through the camera 130. In the embodiment of the disclosure, the processor 110 performs related image processing to generate a depth information (i.e. a depth map image) of the sensing target 200 according to the plurality of reflect optical signals. In the embodiment of the disclosure, the depth sensing device 100 may be applied in the field of visual robots or autonomous driving, but the disclosure is not limited thereto.

In the embodiment of the disclosure, the processor 110 may include, for example, a central processing unit (CPU), a graphic processing unit (GPU), or other programmable general-purpose or special-purpose microprocessor, digital signal processor (DSP), application specific integrated circuit (ASIC), programmable logic device (PLD), other similar processing circuits or a combination of these devices. In the embodiment of the disclosure, the depth sensing device 100 may further include a storage unit, such as a memory. The processor 110 may be coupled to the storage unit. The storage unit may be, for example, a non-volatile memory (NVM). The storage unit may store relevant programs, modules, data or algorithms for realizing various embodiments of the disclosure, for the processor 110 to access and execute to realize the relevant functions and operations described in the various embodiments of the disclosure.

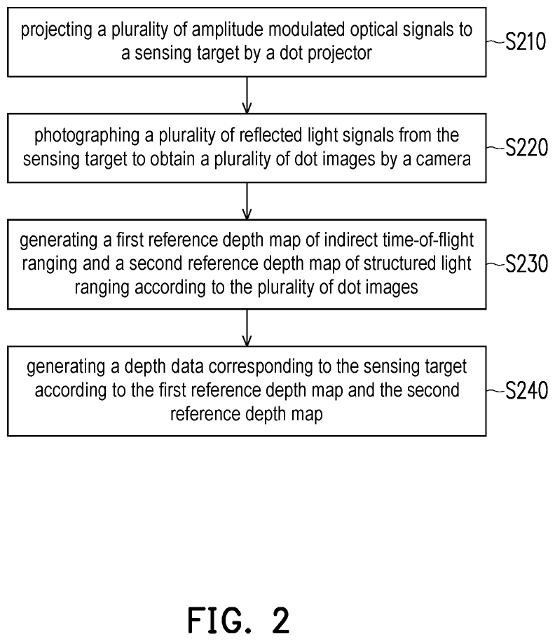

FIG. 2 is a flow chart of a depth sensing method according to an embodiment of the disclosure. Referring to FIG. 1 and FIG. 2, the depth sensing device 100 may execute the following steps S210 to S240 to implement a depth sensing function. In step S210, the dot projector 120 projects a plurality of amplitude modulated optical signals to the sensing target 200. In the embodiment of the disclosure, the dot projector 120 projects the plurality of amplitude modulated optical signals according to a single modulation frequency. The single modulation frequency may be, for example, 100 MHz. Moreover, the any adjacent two of the plurality of amplitude modulated optical signals have a fixed phase difference. The plurality of amplitude modulated optical signals form a plurality of dot patterns on the sensing target 200. In one embodiment of the disclosure, the fixed phase difference may be 90 degrees. The plurality of dot patterns are four dot patterns, and the four dot patterns are sequentially projected on the sensing target 200. It should be noted that the plurality of dot patterns may be implemented for indirect time-of-flight (iToF) ranging and structured light ranging as explained below.

In step S220, the camera 130 photographs a plurality of reflected light signals from the sensing target 200 to obtain a plurality of dot images. In the embodiment of the disclosure, the processor 110 photographs the plurality of dot patterns on the sensing target 200 through the camera 130 to generate the plurality of dot images. In step S230, the processor 110 generates a first reference depth map of indirect time-of-flight ranging and a second reference depth map of structured light ranging according to the plurality of dot images. In the embodiment of the disclosure, the processor 110 may perform related indirect time-of-flight ranging calculations to generate the first reference depth map. The processor 110 may perform related structured light ranging calculations to generate the second reference depth map. The first reference depth map and the second reference depth map are depth image data. Each pixel of the first reference depth map image and the second reference depth map image has a corresponding depth value.

In step S230, the processor 110 generates a depth map corresponding to the sensing target 200 according to the first reference depth map and the second reference depth map. In the embodiment of the disclosure, the processor 110 may perform related data calculations to generate the depth map corresponding to the sensing target 200 according to the first reference depth map and the second reference depth map. That is, the depth sensing device 100 may combine the indirect time-of-flight ranging technology and the structured light ranging technology to achieve accurate depth sensing function. The specific implementations of steps S230 and S240 will be specifically described in the following embodiments.

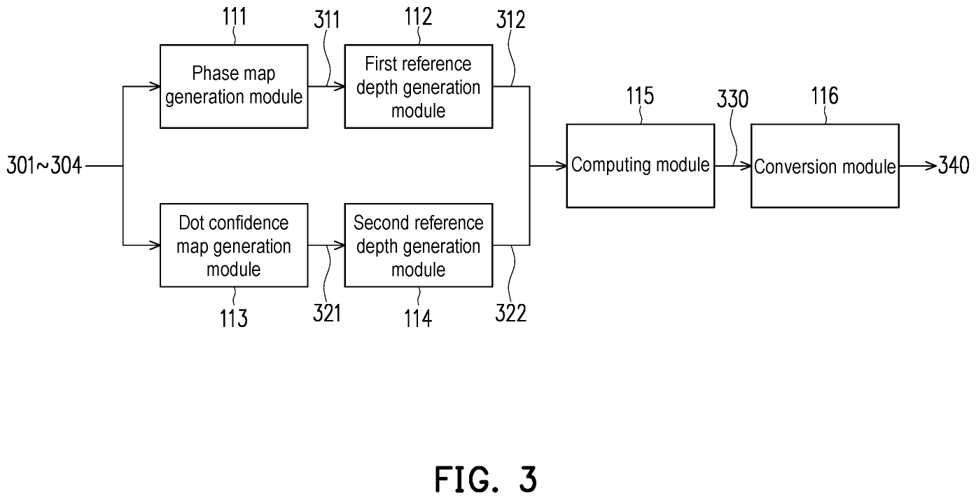

FIG. 3 is a schematic diagram of data processing according to an embodiment of the disclosure. Referring to FIG. 1 and FIG. 3, the storage unit of the depth sensing device 100 may store a phase map generation module 111, a first reference depth generation module 112, a dot confidence map generation module 113, a second reference depth generation module 114, a computing module 115, and a conversion module 116. In the embodiment of the disclosure, the projector 120 may sequentially project the four dot patterns according to the single modulation frequency on the sensing target 200, and the processor 110 may obtain the corresponding four dot images 301 to 304 through the camera 130 photographing the sensing target 200.

In the embodiment of the disclosure, the processor 110 executes the phase map generation module 111 and the first reference depth generation module 112, and uses the corresponding four dot image 301 to 304 as the sensing results of indirect time-of-flight ranging. Thus, the phase map generation module 111 may generate a phase map 311 according to the corresponding four dot images 301 to 304, and the first reference depth generation module 112 may generate a first reference depth map 312 of indirect time-of-flight ranging according to the phase map 311.

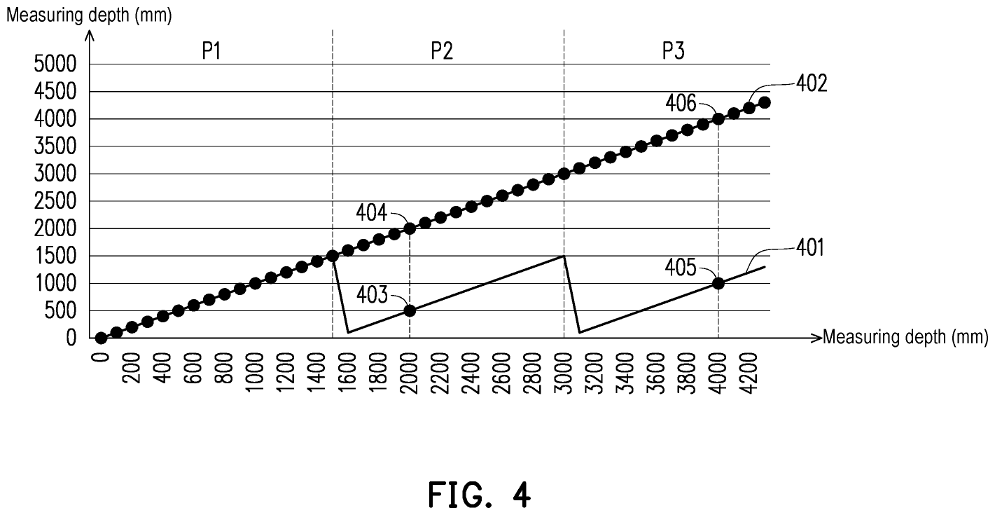

Specifically, the phase map generation module 111 may perform, for example, Fourier transform on the light pulses (i.e. the reflected optical signals) corresponding to the four dot images 301 to 304, and extract the phase information of the Fourier transform result to generate the phase map 311. Each pixel of the phase map 311 represents the phase change of the light pulse corresponding to the pixel. Then, the first reference depth generation module 112 may perform, for example, phase unwrapping on the phase map 311 to generate the first reference depth map 312. For example, as shown in FIG. 4, the line 401 represents multiple indirect time-of-flight ranging results, and the indirect time-of-flight ranging results (measuring depth) that changes in a fixed distance range based on the single modulation frequency. The single modulation frequency may be 100 MHz, thus the fixed distance range may be 1500 mm.

In the embodiment of the disclosure, the processor 110 executes the dot confidence map generation module 113 and the second reference depth generation module 114, and uses the corresponding four dot image 301 to 304 as the sensing results of structured light ranging. The dot pattern projected by the projector 120 may be a dot array pattern for structured light measurement. Thus, the dot confidence map generation module 113 may generate a dot confidence map 321 according to the corresponding four dot images 301 to 304, and the second reference depth generation module 114 may generate a second reference depth map 322 of structured light ranging according to the dot confidence map 321.

Specifically, the dot confidence map generation module 113 may perform, for example, de-noising and calibration processing on the four dot images 301 to 304 to generate the dot confidence map 321 (i.e. a noise reduction image). Then, the second reference depth generation module 114 may perform, for example, a back-projection process to generate the second reference depth map 322 by comparing an original dot pattern image and the second reference depth map 322. For example, as shown in FIG. 4, the line 402 represents multiple structured light ranging results. However, it should be noted that since the accuracy of structured light ranging is positively related (positive correlation) to the distance (i.e. the baseline) between the projector 120 and the camera 130 (in other words, the distance between the projector 120 and the camera 130 may be too close, resulting in poor accuracy of structured light ranging), the present invention does not directly use the ranging result of structured light ranging as the final ranging result.

Then, the processor 110 executes the computing module 115 and the conversion module 116. The computing module 115 may subtract the first reference depth map 312 and the second reference depth map 322 to generate a depth difference map 330, and the conversion module 116 converts the depth difference map 330 to the depth map 340. Specifically, the conversion module 116 may determine that a plurality of depth difference value of the depth difference map 330 respectively corresponds to a plurality of corresponding depth ranges, and calculates the depth map 340 according to the plurality of depth difference value and plurality of corresponding depth ranges. Therefore, the depth sensing device 100 may obtain accurate depth information of the sensing target 200.

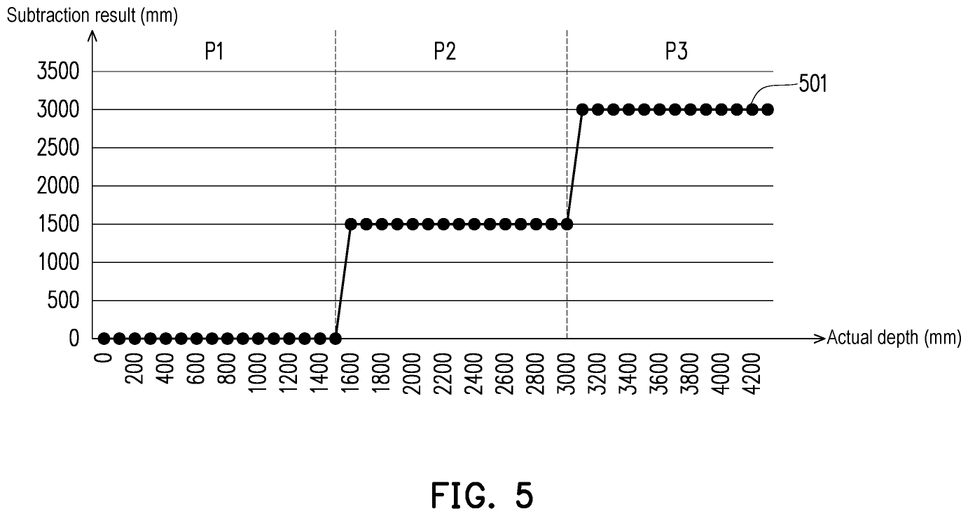

For example, as shown in FIG. 4 and FIG. 5, the line 501 represents subtract results of the structured light ranging results of the line 402 and the indirect time-of-flight ranging results of the line 401. In a first distance range P1, the subtract results of the structured light ranging results of the line 402 and the indirect time-of-flight ranging results of the line 401 may be 0. In a second distance range P2, the subtract results of the structured light ranging results of the line 402 and the indirect time-of-flight ranging results of the line 401 may be 1500 mm (because the single modulation frequency is 100 MHz, and the fixed distance range is 1500 mm). In a third distance range P3, the subtract results of the structured light ranging results of the line 402 and the indirect time-of-flight ranging results of the line 401 may be 3000 mm, and so on.

Taking a ranging result 403 at the line 401 and a ranging result 404 at the line 402 corresponding to one pixel in the depth map as the example, the computing module 115 may subtract the ranging result 404 from the ranging result 403 to obtain a depth difference value “1500”. Then, the conversion module 116 may obtain the corresponding depth range is the second distance range P2 by, for example, a lookup table. Thus, the conversion module 116 may add the ranging result 403 (i.e. 500) and a corresponding preset value (i.e. 1500 (from the lookup table)) corresponding to the second distance range P2 to obtain the measuring depth value (i.e. 500+1500=2000).

Taking another ranging result 405 at the line 401 and another ranging result 406 at the line 402 corresponding to one pixel in the depth map as the example, the computing module 115 may subtract the ranging result 405 from the ranging result 406 to obtain a depth difference value “3000”. Then, the conversion module 116 may obtain the corresponding depth range is the second distance range P3 by, for example, the lookup table. Thus, the conversion module 116 may add the ranging result 405 (i.e. 1000) and another corresponding preset value (i.e. 3000 (from the lookup table)) corresponding to the second distance range P2 to obtain the measuring depth value (i.e. 1000+3000=4000).

In summary, according to the depth sensing device and the depth sensing method of the disclosure, the depth sensing device may utilize one dot project to project the dot patterns on the sensing target, and generate multiple dot images through the camera. The depth sensing device may utilize the multiple dot images to perform indirect time-of-flight ranging and structured light ranging, and calculate accurate depth information of the sensing target through analyzing the ranging results of indirect time-of-flight ranging and structured light ranging.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A depth sensing device, comprising:
a processor;
a dot projector, coupled to the processor, and projects a plurality of amplitude modulated optical signals to a sensing target; and
a camera, coupled to the processor, and photographs a plurality of reflected light signals from the sensing target to obtain a plurality of dot images,
wherein the processor generates a first reference depth map of indirect time-of-flight ranging and a second reference depth map of structured light ranging according to the plurality of dot images, and the processor generates a depth map corresponding to the sensing target according to the first reference depth map and the second reference depth map.

2. The depth sensing device according to claim 1, wherein the dot projector projects the plurality of amplitude modulated optical signals according to a single modulation frequency.

3. The depth sensing device according to claim 1, wherein any adjacent two of the plurality of amplitude modulated optical signals have a fixed phase difference.

4. The depth sensing device according to claim 3, wherein the fixed phase difference is 90 degrees.

5. The depth sensing device according to claim 1, wherein the plurality of amplitude modulated optical signals form a plurality of dot patterns on the sensing target.

6. The depth sensing device according to claim 5, wherein the plurality of dot patterns are four dot patterns, and the four dot patterns are sequentially projected on the sensing target.

7. The depth sensing device according to claim 1, wherein the processor executes a phase map generation module and a first reference depth generation module,
wherein the phase map generation module generates a phase map according to the plurality of dot images, and the first reference depth generation module generates the first reference depth map of indirect time-of-flight ranging according to the phase map.

8. The depth sensing device according to claim 1, wherein the processor executes a dot confidence map generation module and a second reference depth generation module,
wherein the dot confidence map generation module generates a dot confidence map according to the plurality of dot images, and the second reference depth generation module generates the second reference depth map of structured light ranging according to the dot confidence map.

9. The depth sensing device according to claim 1, wherein the processor executes a computing module and a conversion module,
wherein the computing module subtracts the first reference depth map and the second reference depth map to generate a depth difference map, and the conversion module converts the depth difference map to the depth map.

10. The depth sensing device according to claim 9, wherein the conversion module determines that a plurality of depth difference value of the depth difference map respectively corresponds to a plurality of corresponding depth ranges, and calculates the depth map according to the first reference depth map and plurality of corresponding depth ranges.

11. A depth sensing method, comprising:
projecting a plurality of amplitude modulated optical signals to a sensing target by a dot projector; and
photographing a plurality of reflected light signals from the sensing target to obtain a plurality of dot images by a camera;
generating a first reference depth map of indirect time-of-flight ranging and a second reference depth map of structured light ranging according to the plurality of dot images; and
generating a depth map corresponding to the sensing target according to the first reference depth map and the second reference depth map.

12. The depth sensing method according to claim 11, wherein the dot projector projects the plurality of amplitude modulated optical signals according to a single modulation frequency.

13. The depth sensing method according to claim 11, wherein any adjacent two of the plurality of amplitude modulated optical signals have a fixed phase difference.

14. The depth sensing method according to claim 13, wherein the fixed phase difference is 90 degrees.

15. The depth sensing method according to claim 11, wherein the plurality of amplitude modulated optical signals form a plurality of dot patterns on the sensing target.

16. The depth sensing method according to claim 15, wherein the plurality of dot patterns are four dot patterns, and the four dot patterns are sequentially projected on the sensing target.

17. The depth sensing method according to claim 11, wherein the step of generating the first reference depth map of indirect time-of-flight ranging comprises:
generating a phase map according to the plurality of dot images; and
generating the first reference depth map of indirect time-of-flight ranging according to the phase map.

18. The depth sensing method according to claim 11, wherein the step of generating the second reference depth map of structured light ranging comprises:
generating a dot confidence map according to the plurality of dot images; and
generating the second reference depth map of structured light ranging according to the dot confidence map.

19. The depth sensing method according to claim 11, wherein the step of generating the depth map corresponding to the sensing target comprises:
subtracting the first reference depth map and the second reference depth map to generate a depth difference map; and
converting the depth difference map to the depth map.

20. The depth sensing method according to claim 19, wherein the step of converting the depth difference map to the depth map comprises:
determining that a plurality of depth difference value of the depth difference map respectively corresponds to a plurality of corresponding depth ranges; and
calculating the depth map according to the first reference depth map and plurality of corresponding depth ranges.
